(19) United States
(12) Patent Application Publication
(10) Pub. No.: US 2025/0328756 A1
(43) Pub. Date: Oct. 23, 2025

(54) PRIVACY-CONSCIOUS AND ROBUST DETECTION OF ANOMALIES IN COLLABORATIVE AND DISTRIBUTED LEARNING

(71) Applicant: Cypress Semiconductor Corporation, San Jose, CA (US)

(72) Inventors: Tobias SUKIANTO, München (DE); Cecilia CARBONELLI, München (DE); Maximilian STROBEL, Ebershausen (DE); Simon MITTERMAIER, Forstern (DE)

(73) Assignee: Cypress Semiconductor Corporation, San Jose, CA (US)

(21) Appl. No.: 18/641,000

(22) Filed: Apr. 19, 2024

(51) Int. Cl. G06N 3/08

(52) U.S. Cl. CPC G06N 3/08

(57) ABSTRACT

A method includes training, using data collected from sensors, a probabilistic neural network (NN) model including a set of model weights. The probabilistic NN model is trained to filter out data samples causing a threshold level of model uncertainty. The method includes training, at each cycle of training the probabilistic NN model and based on the set of model weights, a common estimator to generate gradient updates to the set of model weights that are to predict whether model updates from the sensors are anomalous. The method includes assigning, to each sensor, a trust coefficient value that estimates a level of trustworthiness of the model updates. The method includes transmitting the set of model weights to a subset of the sensors for which the trust coefficient value satisfies a threshold value.

### TECHNICAL FIELD

This disclosure relates to federated learning and, more specifically, to privacy-conscious and robust detection of anomalies in collaborative and distributed learning.

### BACKGROUND

Traditional sensor learning mechanisms at network edges are based on pre-trained neural network (NN) architectures trained at a central entity and then retrained at the local devices (e.g., sensors) to increase the distributional coverage and containing a wide range of different locations, users, and edge cases that are otherwise intractable to attain during the development phase. For instance, a millimeter wave frequency modulated continuous wave (FMCW) radar or a pulse-based ultra-wideband (UWB) radar may be combined with cameras to collect ground truth information needed for supervised learning and adequately label the data before the NN training. Despite the initial efforts to acquire accurate labels, performance in the operational field often degrades due to the mismatch between the restrictive training distribution and the wide range of test distributions. Another potential application is in the field of predictive maintenance, for example, of smart power supply where devices and their models need to be monitored for defects.

A collaborative and distributed learning technique (such as federated learning (FL)) allows for training models across multiple decentralized devices (e.g., sensors) without exchanging the data the devices hold. In traditional machine learning models, all data is collected and stored centrally, which can be expensive and impractical for data privacy reasons (e.g., camera data for labeling). Distributed learning allows the model to be trained locally on individual devices, and the model updates are sent back to the central entity (e.g., a server or central computing device) that aggregates the model updates and updates the model. This approach has many benefits, including preserving user privacy by keeping the data on the individual devices where the data was generated or sampled, being more efficient for training models on large amounts of data distributions, and allowing for continuous learning and adaptation based on real-world data encountered in the operational environment of the devices.

One of the main challenges in distributed learning is the threat of data poisoning that results in training with anomalous (e.g., malicious) data and/or updates. One type of data poisoning may occur through malicious attacks that deliberately add false or misleading data to the training dataset or provides false gradient information in order to manipulate the behavior of the model. Other types of data poisoning may occur when the sensors send false and corrupting model updates to the server unintentionally, e.g., due to local malfunctioning or failures of a device. Another type of data poisoning may occur through non-deliberate bad data generation where false and misleading information is created for instance due to a radar sensor that is falsely calibrated or obstructed due to adverse weather conditions or obstacles. In general, data poisoning that falls into the category of malicious attacks do not recover from their defect state, whereas non-deliberate or unintentional data poisoning events are more likely to recover (e.g., obstacle is removed, weather condition gets better, and the like). Data poisoning can be particularly dangerous in distributed learning because the data used for training is distributed across multiple devices and servers, making it more difficult to detect and mitigate these types of attacks or events and even more accentuated in the scope of sensor networks including many participating client devices.

### BRIEF DESCRIPTION OF THE DRAWINGS

FIG. 1 is a block diagram of an exemplary network for performing collaborative and distributed learning according to various embodiments.

FIG. 2A is a flow diagram of an example method for performing collaborative and distributed learning using a network of sensors according to some embodiments.

FIG. 2B is a flow diagram of an example method for performing collaborative and distributed learning using a network of sensors according to additional embodiments.

FIG. 3A is a flow diagram of an example method for performing collaborative and distributed learning that provides a privacy-conscious and robust detection of anomalies according to various embodiments.

FIG. 3B is a flow diagram of a more detailed set of operations for operation 346 of the method of FIG. 3A according to some embodiments.

FIG. 4A is a flow diagram of a variational autoencoder (VAE) architecture employing loss minimization to detect anomalous model updates according to some embodiments.

FIG. 4B is a flow diagram of a VAE algorithm depiction of the VAE architecture of FIG. 4A according to some embodiments.

FIG. 5A is a flow diagram of a variational autoencoder (VAE) architecture employing VAE latent space to detect anomalous model updates according to some embodiments.

FIG. 5B is a flow diagram of a VAE algorithm depiction of the VAE architecture of FIG. 5A according to some embodiments.

FIG. 6 illustrates a block diagram illustrating an exemplary computer device 700, in accordance with implementations of the present disclosure.

### DETAILED DESCRIPTION

The following description sets forth numerous specific details such as examples of specific systems, devices, components, methods, and so forth, in order to provide a good understanding of various embodiments of privacy-conscious and robust detection of anomalies in collaborative and distributed learning. Collaborative and distributed learning is a relatively new field in distributed optimization where data collection and model training are decentralized and take place on many edge clients with limited communication and computation capabilities. Unlike traditional machine learning (ML), distributed learning involves a subset of client devices each performing multiple local updates before the model updates are aggregated to update a global NN/ML model in each communication round. Only weight updates are exchanged (which can flow in both directions) and sensitive user data never leaves the device (e.g., does not flow between clients and server). Examples of collaborative and distributed learning include federated learning (FL), split learning, multi-party computation (MPC), differential privacy (DP), decentralized learning, blockchain-based learning, and other model aggregation techniques and protocols such as Federated Learning's Federated Averaging (FedAvg), Federated Stochastic Variance Reduced Gradient (FSVRG), and Secure Aggregation protocols. While distributed learning is often generally explained at server and client levels, the present disclosure addresses applications in which the server can be any centralized computing device and the clients can be deployed as intelligent sensors, which will be discussed in more detail.

With the rise and quantity of client devices, undesired phenomenon have become an increasing concern, such as malicious client device(s) that seek to negatively influence the training procedure with data poisoning attacks and false model updates that may prevent the model from converging. As discussed previously, some client devices may also unintentionally send corrupt or inaccurate data or updates due to temporally malfunctioning client devices (e.g., obstructed sensors or changing environmental conditions). Thus, current distributed learning architectures and approaches seek to limit or at least detect malicious (or anomalous) data or model updates. Many current approaches falsely misclassify non-malicious clients as malicious and exclude such non-malicious clients permanently from participating in model training. The disadvantage of this approach is missing out on the data and updates from non-malicious clients that would otherwise help more accurately train the global NN/ML model.

Aspects of the present disclosure resolve these and other deficiencies with known approaches to employing collaborative and distributed learning by selectively using some data samples and model updates while rejecting other data samples and model updates considered to be anomalous, which selective decisions may be updated over time and optionally updated periodically for retraining based on changing environmental conditions. In this way, if anomalies are detected that are unintentional or temporary (e.g., obstructed or defective sensors) and are able to be cleared up, then what may appear as anomalous sensors may still provide useful data at some point in the future. More specifically, the present disclosure is directed at a probabilistic deep learning approach that protects against data poisoning attacks, e.g., avoiding use of sampled data in training a probabilistic NN model that would negatively affect the training procedure of each sensor. Further, the present disclosure is directed at use of a common estimator (or variational autoencoder) anomaly detection framework that predicts whether model updates are invalid or anomalous. If considered anomalous, one or more updates are not used in further training of the common estimator. Each sensor may also be assigned a trust coefficient that influences a level of contribution of model updates from each sensor to training the global probabilistic NN model.

By way of example, in some embodiments, a central computing device trains, using data collected from a plurality of sensors, a probabilistic NN model to generate a set of model weights. The probabilistic NN model may be trained to filter out data samples causing a threshold level of model uncertainty. The central computing device may further train, at each cycle of training the probabilistic NN model and based on the set of model weights, a common estimator to generate gradient updates to the set of model weights. These gradient updates may predict whether the model updates from the plurality of sensors are anomalous. The central computing device may further assign, to each sensor of the plurality of sensors, a trust coefficient value that estimates a level of trustworthiness of the model updates. Over time, the trust coefficient may be updated for each sensor based on results from the common estimator, and thus, the trust coefficient may get worse or improve over time depending on estimates of model update validity. The central computing device may further transmit the set of model weights to a subset of sensors of the plurality of sensors for which the trust coefficient value satisfies a threshold value.

In some embodiments, a sensor receives, from the central computing device, a local probabilistic neural network (NN) model having an initial set of model weights. The sensor may train the local probabilistic NN model, including determining a subset of useable data samples by identifying those of a plurality of data samples having a model uncertainty below a threshold value. The sensor may then train the local probabilistic NN model with the useable data samples to generate updated model weights. The sensor may further transfer the updated model weights to the central computing device for use in training, along with other updated model weights from other distributed sensors, the global probabilistic NN model.

Advantages of the present disclosure include, but are not limited to, avoiding the exclusion of relevant data samples from sensors that may, at one time or another, be considered to be anomalous (otherwise referred to in the art as malicious). The advantages may further include filtering out, using a common estimator, untrustworthy or anomalous model updates to protect against model poisoning. Further, the present disclosure includes thresholding trustworthiness of model updates from each sensor using a trust coefficient such that more trustworthy model updates contribute more to retraining the common estimator, but not completely ignoring other model updates that at least meet a threshold level of trustworthiness. The net effect of these advantages is considering good data samples and most model updates, while weighting the model updates according to trustworthiness, leading to more data samples and model updates from which to more-accurately train the common estimator for future rounds of NN model training. Additional advantages will be apparent to those skilled in the art of collaborative and distributive learning and other distributed learning, as are further discussed below.

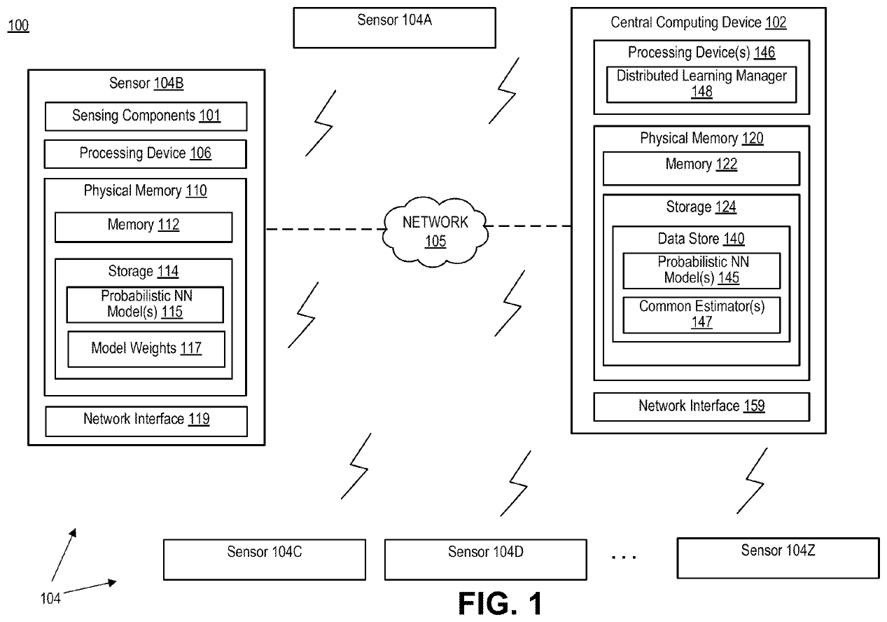

FIG. 1 is a block diagram of an exemplary network 100 for performing collaborative and distributed learning according to various embodiments. In disclosed embodiments, for example, the network 100 includes sensors 104 communicatively coupled with a central computing device 102 over a network 105. In some embodiments, the sensors 104 are distributed throughout an automobile or vehicle and the central computing device 102 is a primary microcontroller or network device that gathers model updates from the sensors 104 in order to train a global probabilistic NN model. In such embodiments, at least some of the sensors are radar sensors, as was discussed. At least some of these radar sensors may capture and track hand movements in relation to a console of the vehicle. Other contexts and applications are also envisioned, including environmental sensors distributed throughout a home or commercial property, maintenance sensors that track a status or health of various components of a machine, computer, or apparatus, and others that would be apparent to those skilled in the art of sensors.

In at least some embodiments, the sensors 104 are a plurality of sensors including a first sensor 104A, a second sensor 104B, a third sensor 104C, a fourth sensor 104D, and so forth through a final sensor 104Z. Only by way of example, one or more of the sensors 104 may include, in addition to sensing components 101 (such as a physical sensor and related sensing electronics), a processing device 106, a physical memory 110, and a network interface 119. In embodiments, the physical memory 110 includes a memory 112 (e.g., volatile memory and/or cache memory) and storage 114 (e.g., non-volatile memory). The network interface 119 may be configured to communicate through the network 105 with the central computing device 102 but not necessarily with other sensors 104.

In some embodiments, the physical memory 110 stores and/or buffers instructions executable by the processing device 106 and/or data generated by sensing components 101 and the processing device 106. For example, the storage 114 may store and the memory 112 may buffer a probabilistic NN model 115 (e.g., a local probabilistic NN model) and associated model weights 117, which may be updated over time as the sensor 104B trains the probabilistic NN model 115. Thus, the processing device 106 and the physical memory 110 may at least include a microcontroller or basic processing device sufficient to perform at least basic machine learning. In this way, the sensors 104 may be considered to be intelligent sensors capable of a certain level of processing and storage.

In some embodiments, the central computing device 102 includes one or more processing devices 146, a physical memory 120, and a network interface 159. The network interface 159 may be configured to communicate through the network 105 with the sensors 104 and potentially with other central or distributed computing devices that are themselves communicatively coupled to other distinct sensors. In this way, multiple sub-networks can be combined into a larger network for NN training and processing. In some embodiments, the sensors 104 and the central computing device 102 are wired and/or wirelessly coupled to the network 105, e.g., to a network device such as a hub, an access point, a switch, or the like.

In embodiments, the physical memory 120 includes a memory 122 (e.g., volatile memory and/or cache memory) and storage 124 (e.g., non-volatile memory). For example, the storage 124 may store and the memory 122 may buffer a probabilistic NN model 145 (e.g., a global probabilistic NN model), associated model weights, and a common estimator 147 that may be updated over time as the central computing device 102 trains the probabilistic NN model 145 and the common estimator 147. Thus, the processing device 146 and the physical memory 120 may at least include a microcontroller or enhanced processing device or system sufficient to perform at least the machine learning described herein associated with training the probabilistic NN model 145 and the common estimator 147. In embodiments, the common estimator 147 is a variational autoencoder (VAE), a feed-forward neural network, logistic regression logic, maximum likelihood estimator, a maximum a posterior estimator, or the like. In some embodiments, a data store 140 positioned within the storage 124 is configured to securely store the probabilistic NN model 145 and the common estimator 147, which can thus be updated and persist through power cycling of a device or system in which the central computing device 102 operates.

In various embodiments, hardware, firmware, and/or software of the central computing device 102 and the sensors 104 (e.g., located in or associated with the network interface 119 and 159, respectively) are adapted with or configured for wireless local area network (WLAN) and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wireless Smart Utility Network® (Wi-SUN®), or other wireless protocol. While some of the protocols may also be referred to as personal area network (PAN) technology, for simplicity, all are broadly referred to as WLAN technology. Future protocols are also envisioned.

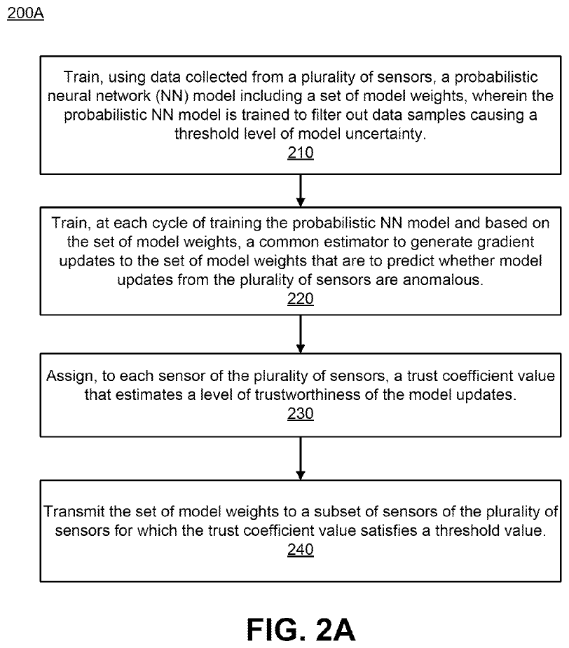

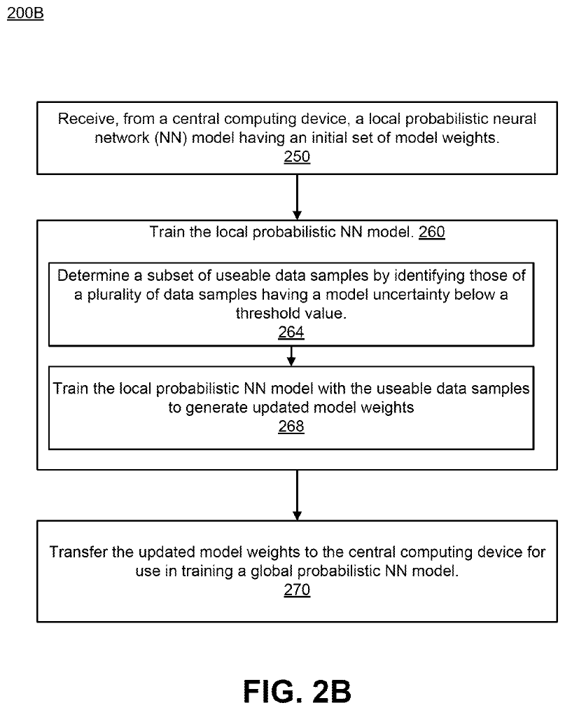

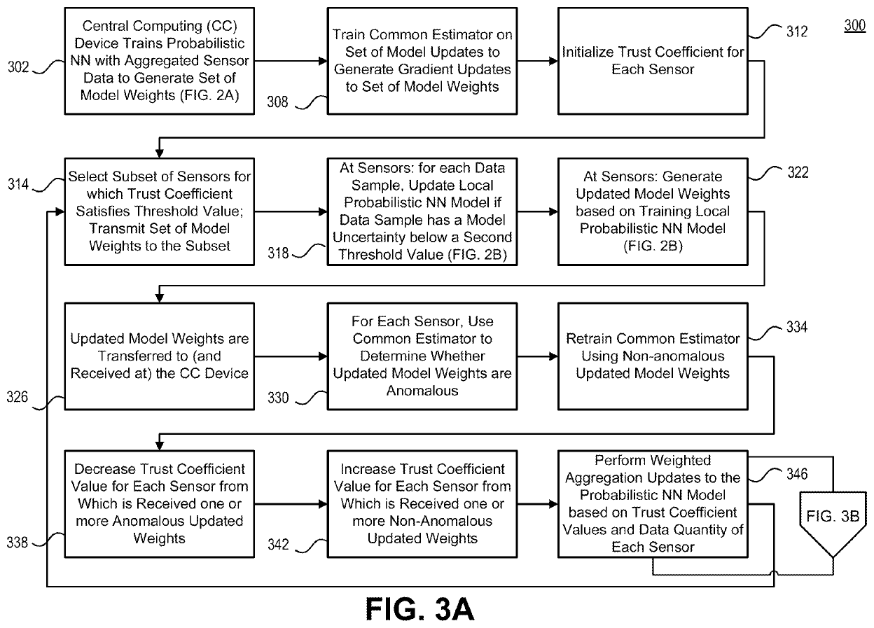

FIG. 2A is a flow diagram of an example method 200A for performing collaborative and distributed learning using a network of sensors according to some embodiments. In at least one embodiment, the method 200A is performed by processing logic of the central computing device 102. The processing logic can be a combination of hardware, firmware, software, or any combination thereof. The method 200A may be performed by one or more processing devices (e.g., a microcontroller, a programmed processor, a central processing unit (CPU), and/or graphical processing unit (GPU), or the like), which may include (or communicate with) one or more memory devices. In at least one embodiment, the method 200A is performed by multiple processing threads, each thread executing one or more individual functions, routines, subroutines, or operations of the method 200A. In at least one embodiment, processing threads implementing method 200A may be synchronized (e.g., using semaphores, critical sections, and/or other thread synchronization logics). Alternatively, processing threads implementing the method 200A may be executed asynchronously with respect to each other. Various operations of method 200A may be performed in a different order compared with the order shown in FIG. 2A. Some operations of the methods may be performed concurrently with other operations. In at least one embodiment, one or more operations shown in FIG. 2A may not always be performed.

At operation 210, the processing logic trains, using data collected from a plurality of sensors, a probabilistic NN model that includes a set of model weights. For example, the probabilistic NN model 145 (FIG. 1) may be trained to filter out data samples causing a threshold level of model uncertainty. This threshold level of uncertainty may be associated with a particular threshold uncertainty value that is compared against computed model uncertainty values for the data samples, as will be explained in more detail.

At operation 220, the processing logic trains, at each cycle of training the probabilistic NN model and based on the set of model weights, a common estimator to generate gradient updates to the set of model weights. In some embodiments, the gradient updates predict whether model updates from the plurality of sensors are anomalous.

At operation 230, the processing logic assigns, to each sensor of the plurality of sensors, a trust coefficient value that estimates a level of trustworthiness of the model updates.

At operation 240, the processing logic transmits the set of model weights, by the central computing device, to a subset of sensors of the plurality of sensors for which the trust coefficient value satisfies a threshold value. This threshold value may be programmable to update, in real time, the sensitivity of the training in relation to desired trustworthiness of the model updates provided by the plurality of sensors.

FIG. 2B is a flow diagram of an example method 200B for performing collaborative and distributed learning using a network of sensors according to additional embodiments. In at least one embodiment, the method 200B is performed by processing logic of a sensor 104 of the plurality of sensors. The processing logic can be a combination of hardware, firmware, software, or any combination thereof. The method 200B may be performed by one or more processing devices (e.g., a microcontroller, a programmed processor, a central processing unit (CPU), and/or graphical processing unit (GPU), or the like), which may include (or communicate with) one or more memory devices. In at least one embodiment, the method 200B is performed by multiple processing threads, each thread executing one or more individual functions, routines, subroutines, or operations of the method 200B. In at least one embodiment, processing threads implementing method 200B may be synchronized (e.g., using semaphores, critical sections, and/or other thread synchronization logics). Alternatively, processing threads implementing the method 200B may be executed asynchronously with respect to each other. Various operations of method 200B may be performed in a different order compared with the order shown in FIG. 2A. Some operations of the methods may be performed concurrently with other operations. In at least one embodiment, one or more operations shown in FIG. 2A may not always be performed.

At operation 250, the processing logic receives, from a central computing device, a local probabilistic neural network (NN) model having an initial set of model weights. This local probabilistic NN model may stored locally on the sensor 104, updated and trained locally in the sensor 104.

At operation 260, for example, the processing logic trains the local probabilistic NN model, e.g., the probabilistic NN model 115 (FIG. 1).

Specifically operation 260 may include at least operations 264 and 268. At operation 264, the processing logic determines a subset of useable data samples by identifying those of a plurality of data samples having a model uncertainty below a threshold value. At operation 268, the processing logic trains the local probabilistic NN model with the useable data samples to generate updated model weights.

At operation 270, the processing logic transfers the updated model weights to the central computing device for use in training the global probabilistic NN model, e.g., the probabilistic NN model 145 (FIG. 1).

In some embodiments, the method 200B may further include the processing logic receiving, from the central computing device 102, further updated weights based on further training of the global probabilistic NN model 145. The processing logic may further train the local probabilistic NN model 115 using the further updated weights, e.g., in another iteration of training.

With continued reference to FIG. 1, the global and local probabilistic NN models 145 and 115 may both be applied to noisy data samples, adversarial data samples, data poisoning, and poor quality data samples. Benefits from training these probabilistic NN models may include minimizing risk of anomalous data poisoning attacks, detecting poor quality data samples, and detecting potentially defective clients that create bad, e.g., anomalous, data unintentionally.

In some embodiments, the local probabilistic NN model 115 is an ensemble of classifiers or a set of Monte Carlo dropout samples. In such embodiments, the method 200B may further include the following operations performed during inference using the local probabilistic NN model. For example, the processing logic may average probabilities predicted by each individual classifier in the ensemble or the set of Monte Carlo dropout samples generated. The processing logic may further execute the local probabilistic NN model a plurality of times with dropout enabled, each time obtaining predictions using a different dropout mask. The processing logic may further average predictions for each class across the plurality of data samples to obtain the model uncertainty.

For example, in the context of filtering out the noisy data samples in the sensors with probabilistic inference via an ensemble of classifiers or Monte Carlo dropout, the model uncertainty may be obtained by averaging the probabilities predicted by each individual classifier in the ensemble or the different number of Monte Carlo samples (dropout masks) generated during inference. Also during inference, the network 100 may be run T times with dropout enabled, and each time the predictions may be obtained using a different dropout mask. The predictions for each class across the T samples may be combined or aggregated to obtain the model uncertainty. The sample variance or entropy of these predictions can be used as a measure of epistemic uncertainty, which makes reference to uncertainty of the probabilistic NN model 115 as opposed to uncertainty a certain type of data on which the model relies. This ensemble approach may be expressed as follows:

$$λ = \{ \begin{matrix}1 , & if \hat{{u}_{ι}} < {μ}_{unc} \\ 0 , & otherwise\end{matrix}$$

$${L}_{S} = {\sum }_{c = 0}^{C} λ ( {y}_{i , c} log ( {\hat{p}}_{i , c} ) ) ,$$

where \hat{p}_{i,c} is the predicted probability of sample i belonging to class c based on an output of the model, K is the number of classifiers in the ensemble,

$${\hat{p}}_{i , c}^{( k )}$$

is the probability predicted by the kth classifier or number of Monte Carlo samples (dropout masks) generated during the inference for sample i belonging to class c, and ûᵢ represents the estimated uncertainty for sample i. Also, y_{i,c}∈{0,1} is the ground truth label of sample i belonging to class c.

In other embodiments, the local probabilistic NN model 115 is an Evidential Deep Learning (EDL) model. In such embodiments, the method 200A further includes performing the following operations during inference using the local probabilistic NN model 115. For example, the processing logic may determine estimates of the model uncertainty for each data sample. The processing logic may exclude, from training the local probabilistic NN model, data samples for which the model uncertainty at least satisfies the threshold value.

For example, EDL can be used instead of Monte Carlo Dropout to capture the model uncertainty and filter out the bad or anomalous data in the sensors 104 since EDL may require only one inference pass and thus may be computationally more efficient. In this approach, the probabilistic NN model 115 first makes predictions on the sensor data and estimates the associated uncertainties. Data filtering is then performed by considering the estimated uncertainty. Data that has high uncertainty may be excluded from the sensor training procedure, potentially being anomalous data. By incorporating uncertainty in the data selection, the probabilistic NN model 115 can be more cautious and prevent model degradation due to bad quality data. This helps in reducing the potential negative impact of incorrectly labeled samples and noisy data. The integration of EDL in a sensor network may provide a powerful framework for leads to improved model performance and robustness, which may be expressed as follows:

$${μ}_{u n c} = max ( {τ}_{start} + \frac{{μ}_{e n d} - {μ}_{start}}{decay\_duration} \times {current}_{step} , {μ}_{e n d} )$$

$$λ = \{ \begin{matrix}1 , & if \hat{{u}_{ι}} < {μ}_{unc} \\ 0 , & otherwise\end{matrix}$$

$${L}_{S} = {\sum }_{c = 0}^{C} λ ( {y}_{i , c} log ( {\hat{p}}_{i , c} ) ) .$$

Here, currentₛₜₑₚ ∈N is the number of training iterations between the central computing device 102 and each sensor 104, and decay_duation∈N determines how many training iterations between the central computing device 102 and the sensors 104 are required to go between the threshold values μₛₜₐᵣₜ∈R to μ_{end}∈R.

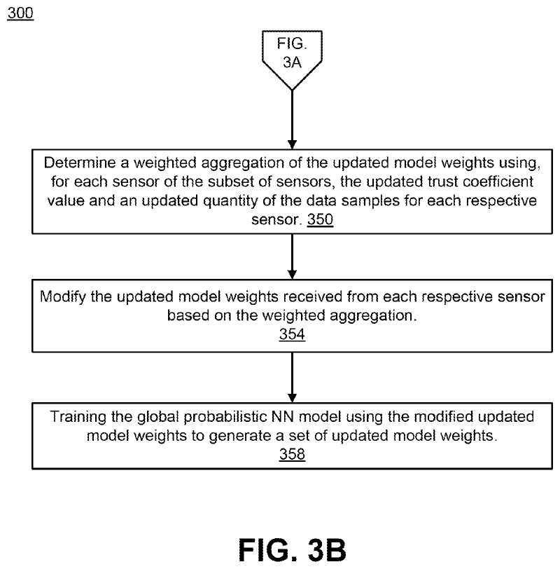

FIG. 3A is a flow diagram of an example method 300 for performing collaborative and distributed learning that provides a privacy-conscious and robust detection of anomalies according to various embodiments. FIG. 3B is a flow diagram of a more detailed set of operations for operation 346 of the method 300 of FIG. 3A according to some embodiments. In at least some embodiments, the method 300 is performed by processing logic of the central computing device 102 (discussed in relation to the method 200A of FIG. 2A) and of the sensor 104 (discussed in relation to the method 200B of FIG. 2B). For example, all but operations 318 and 322 may be performed by the central computing device 102, while operation 326 may be performed by both the sensor 104 and the central computing device 102. Some of the operations of the method 300 may be performed in a different order than that illustrated, unless explicitly explained to require an order, and some of the operations are intended to provide a loop for which different communication cycles lead to multiple iterations of training the local and global probabilistic NN models and the common estimator.

At operation 302, the processing logic trains the probabilistic NN model 145 using the N available data samples D_{S}={(x₁, y₁), . . . , (x_{N}, y_{N})} at the central computing device, which generates a set of model weights w₁^{avg}.

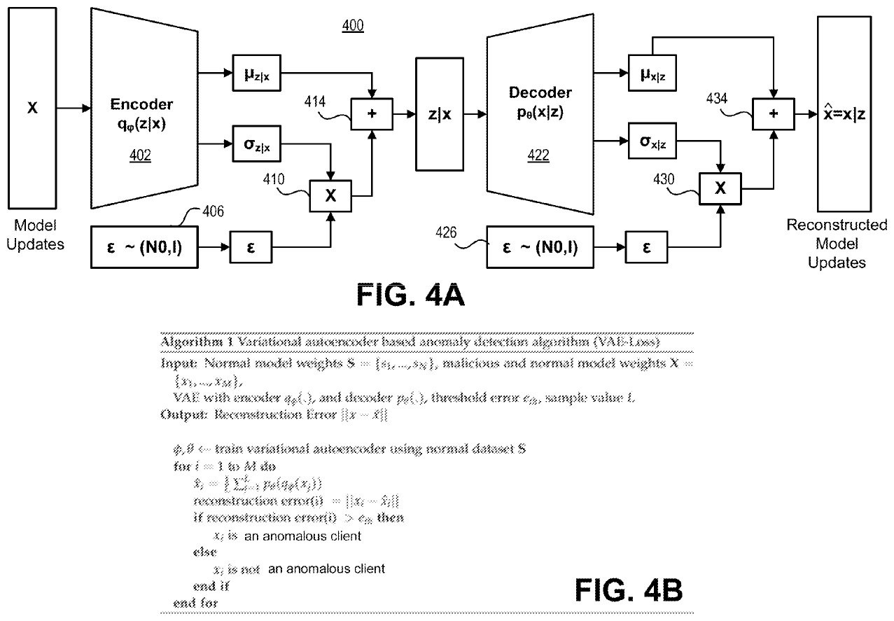

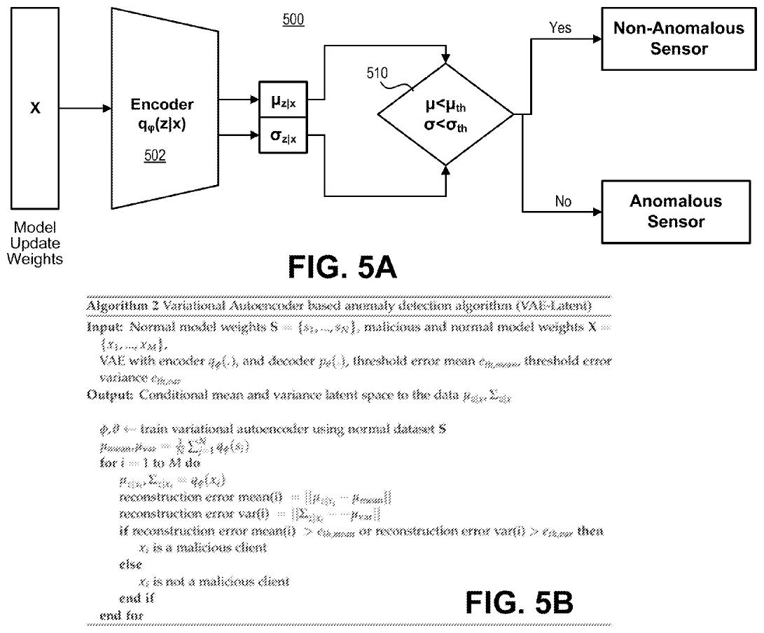

At operation 308, the processing logic trains, at each cycle of training the probabilistic NN model 145 and based on the set of model weights, a common estimator 147 to generate gradient updates to the set of model weights that are to predict whether model updates from the sensors are anomalous. In some embodiments, the common estimator 147 is a variational autoencoder (VAE). In embodiments, at each gradient step during training, the model updates are collected {w₁, . . . , w_{N}} and the VAE, with encoder f(·) and decoder g(·), is trained to reconstruct the model weights ŵ=g(f(w)), where w and ŵ corresponds to the original and reconstructed model weights respectively. Functionality of the VAE herein will be discussed in more detail with reference to FIGS. 4A-4B and FIGS. 5A-5B.

At operation 312, the processing logic initializes a trust coefficient for each sensor of the plurality of sensors 104. This initialization of the trust coefficients may be a way of assigning a trust coefficient to each sensors, and may need only be done once when each respective sensor is brought online within the network 100 and initially communicatively coupled to the central computing device 102.

At operation 314, the processing logic selects a subset of sensors of the plurality of sensors 104 having a trust coefficient that satisfies a threshold value, e.g., a threshold trust value. In some embodiments, this means that the trust coefficient for a given sensor is greater or equal to the threshold value. Also at operation 314, the processing logic transmits the set of model weights (generated at operation 302) to the subset of sensors (e.g., K clients).

At operation 318, the processing logic (at the sensors 104) for each data sample, updates the (local) probabilistic NN model 115 if the data sample has a model uncertainty below a second threshold value (e.g., a model uncertainty value). More specifically, the selected sensors (in the subset) may each initialize a respective local probabilistic NN model with the set of model weights w_{avg}¹ and use respective nᵢ∈N data samples to train the local model probabilistic NN model 115. As described with reference to FIG. 2B, each data sample (x, y) is only taken into consideration for the training if the model uncertainty is below the threshold value, u(x)<μ_{unc}, as expressed in the following:

$${L}_{S} = {\sum }_{c = 0}^{C} λ ( {y}_{i , c} log ( {\hat{p}}_{i , c} ) ) , λ = 0 ,$$

$$for u ( x ) \geq {μ}_{unc} , and λ = 1 , for u ( x ) < {μ}_{unc} .$$

At operation 322, the processing logic (at the sensors 104) generate updated model weights based on training the local probabilistic NN model 115.

At operation 326, the processing logic (of the sensors) transfers to and (of the central computing device) receives the updated model weights generated at the respective sensors. For example, the processing logic (of the central computing device) receives, from each sensor of the subset of sensors, updated model weights for the probabilistic NN model after training a local instance of the probabilistic NN model.

At operation 330, the processing logic evaluates, with the common estimator, the updated model weights to classify one or more of the updated model weights as anomalous.

At operation 334, the processing logic retrains the common estimator using non-anomalous updated model weights from the central computing device 102 and the subset of sensors. For example, the processing device may exclude, in retraining the common estimator 147, one or more of the updated model weights determined to be anomalous.

At operations 338 and 342, the processing logic updates the trust coefficient value associated with the sensor based on whether each respective updated model weight is classified as anomalous. For example, at operation 338, the processing logic decreases the trust coefficient value in response to detecting an updated model weight, of the updated model weights, is anomalous. At operation 342, the processing logic increases the trust coefficient value in response to detecting an updated model weight, of the updated model weights, is non-anomalous. In this way, the trust coefficient value for each sensor may vary over time. While a trust coefficient value may be degraded based on unintentional data or model update poisoning, the trust coefficient value may recover and improve in subsequent model updates in which the data or model update poisoning is removed or mostly removed.

In some embodiments, employing a trust coefficient value in a way that increases and decreases with degree of maliciousness, e.g., detected anomalies, enables applying the disclosed methods to large sensor networks, with a high number of participating sensors that previously could not be examined, and weighting the trustworthy sensors more in the aggregation than the untrustworthy sensor. In this way, by thresholding the trust coefficient values, the network 100 benefits from minimizing the influence of anomalous (or malicious) sensors, maximizes model accuracy, and detects potentially defective client that create defective model updates.

At operation 346, the processing logic performs weighted aggregation updates to the global probabilistic NN model 145 based on the trust coefficient of each respective sensor and a quantity of data samples for each respective sensor. With additional reference to FIG. 3B for a more specific explanation of operation 346, the processing logic, at operation 350, determines a weighted aggregation of the updated model weights using, for each sensor of the subset of sensors, the updated trust coefficient value and an updated quantity of the data samples for each respective sensor. For example, the processing logic may perform a weighted update (here, a weighted average only by way of example) according to the following update rule that considers both trust coefficient values (τ) and data quantity (nᵢ) in each respective sensor:

$${w}_{a v g} = \frac{{\sum }_{i} \frac{{n}_{i}}{n} \frac{{τ}_{i}}{τ} {w}_{i}}{{\sum }_{i} \frac{{n}_{i}}{n} \frac{{τ}_{i}}{τ}} .$$

At operation 354, the processing logic modifies the updated model weights received from each respective sensor based on the weighted aggregation.

At operation 358, the processing logic trains the probabilistic NN model using the modified updated model weights to generate a set of updated model weights. The operations of FIG. 3B allows for the anomalous clients to be still taken into consideration during training, albeit at a reduced weighted influence. This approach enables extracting the relevant information even from anomalous sensors (also referred to malicious clients in the art). Furthermore, sensors that are anomalous for some training iterations have the chance to recover and increase their trust coefficient value, facilitating a dynamic and lifelong-learning environment.

With continued reference to FIG. 3A, after operation 346 is completed, the method 300 may loop back to operation 314, transmitting the set of updated model weights to the subset of sensors for which the trust coefficient value satisfies the threshold value. The method 300 may then continue to iterate through the training of the local probabilistic NN models at the sensors (operation 318) to generate update model weights that are then transferred back to the central computing device 102 for aggregation and further training as was previously discussed. In some embodiments, the updated model weights are transferred back to the central computing device 102 on a particular schedule or when triggered to do so by the central computing device 102.

With reference to FIGS. 4A-4B, a VAE-based anomaly detection framework may be understood as an advanced machine learning approach that utilizes the principles of variational autoencoders for identifying anomalies or outliers in data. Variational Autoencoders are a type of generative model that are particularly well-suited for this task due to their ability to learn complex data distributions in an unsupervised manner. In the context of this disclosure, VAE architectures can be applied to anomalous model updates, detecting anomalous (e.g., malicious) sensors, and detecting defective sensors. Accordingly, the benefits of employing the VAE architectures include excluding malicious updates from the training procedure, improving protection against anomalous clients, and pinpointing and repairing defective sensor devices.

FIG. 4A is a flow diagram of a variational autoencoder (VAE) architecture 400 employing loss minimization to detect anomalous model updates according to some embodiments. FIG. 4B is a flow diagram of a VAE algorithm depiction of the VAE architecture of FIG. 4A according to some embodiments. In this first approach (VAE-Loss), a complete VAE structure is employed by processing logic of the central computing device 102 to detect anomalies based on reconstruction error during model inference according to the following operations that generally flow from left to right through the VAE architecture 400.

In various embodiments, updated model updates (x) for the probabilistic NN model 145 are received from the sensors 104. These original updated model weights are mapped to a lower-dimensional latent space where anomalies and normal data are expected to be separated. More specifically, the processing logic compresses, using an encoder 402, the updated model weights to a latent space of a lower dimension compared to that of the updated model weights. This compression to the latent space may generate a Gaussian distribution in the latent space for each sampled data point that is characterized by mean values (μ) and variance values (σ). For example, a Gaussian generator 406 may generate a random white Gaussian number (ε) that may sample the variance value, e.g., using a multiplier 410, for each updated model weight. The sampled variance value(s) may then be combined, using an adder 434, with the corresponding mean values to generate the latent space (z|x).

In some embodiments, the processing logic remaps, using a decoder 422, the updated model weights from the latent space to generate reconstructed updated model weights (\hat{x}) in the original data space (x), but given the latent space (x|z). More specifically, the decoder 422 generates new mean values (μ) and variance values (σ) from the mapped/compressed latent space (z|x). A similar process can then be replicated as was performed for the encoder 402 with a Gaussian generator 426, a multiplier 430, and an adder 434 to generate the reconstructed updated model weights (x).

In at least some embodiments, the processing logic determines reconstruction errors between the updated model weights and the reconstructed updated model weights, e.g., expressed as ∥xᵢ−\hat{x}ᵢ∥ in FIG. 4B. The processing logic may then classify, as anomalous, one or more of the updated model weights having a corresponding reconstruction error that satisfies a second threshold value (eₜₕ). For example, satisfying the second threshold value may include the reconstruction error being greater than the second threshold value. In this way, the reconstruction error functions as an anomaly score that enables the detection of anomalies, which will determine whether a corresponding updated model weight is employed is retraining the common estimator 147. Datapoints with higher reconstruction errors are considered anomalies (malicious), whereas data points with lower reconstruction errors are considered non-anomalies (non-malicious).

In embodiments, anomaly detection is conducted by training the VAE architecture 400 only using model updates from non-anomalous clients for training. The probabilistic encoder 402 or q(·) parameterizes a normal distribution within the latent space with learnable mean and variance. In contrast, the probabilistic decoder 422 or p(·) outputs the reconstructed mean of the latent variable z|x. Introducing these stochastic properties allows for increased robustness by outputting a de-noised version of the Gaussian distribution and serves as a regularization term. In the VAE architecture 400, the complete VAE structure may thus be used to detect anomalies based on reconstruction error during model inference.

FIG. 5A is a flow diagram of a variational autoencoder (VAE) architecture 500 employing VAE latent space to detect anomalous model updates according to some embodiments. FIG. 5B is a flow diagram of a VAE algorithm depiction of the VAE architecture of FIG. 5A according to some embodiments. Because the VAE architecture 400 (of FIGS. 4A-4B) employs both an encoder and a decoder, this VAE-Loss approach may consume more storage space and be more computationally expensive than the VAE architecture 500, which employs half the components. By reducing the component count, the VAE architecture 500 may save in both storage space and processing consumed, which may benefit performing the disclosed distributed training on intelligent sensors with microcontrollers having limited resources.

More specifically, the VAE architecture 500 (e.g., VAE-Latent) includes just an encoder 502 and a set of comparators 510 for comparing latent space probabilistic values (e.g., mean of cluster centrals) to certain thresholds. Thus, the operations may be simplified to the following operations. In embodiments, processing logic of the central computing device 102 receives, from a sensor of the subset of sensors, updated model weights for the probabilistic NN model. The processing logic may then compress, using the encoder 502, the updated model weights to a latent space of a lower dimension compared to that of the updated model weights. The processing logic may then calculate, from the latent space, a mean of cluster centrals of the latent space using an existing dataset (e.g., the updated model weights received from the sensor).

In some embodiments, the mean of cluster centrals includes probabilistic determinations for mean values (μ) and/or variance values (σ) in latent space, as illustrated in the VAE algorithm of FIG. 5B. The processing device may then calculate a distance value between encoded samples, of the updated model weights, and the mean of cluster centrals, e.g., that results in reconstruction error mean(i) and/or reconstruction error var(i) in FIG. 5B, where “var” is short for variance. The processing device may then classify as anomalous one or more of the updated model weights having a distance value that exceeds a threshold distance value. For example, the set of comparators 510 may include a first comparator to compare the reconstruction error mean(i) to a mean threshold value (e_{th,mean}) and classify a corresponding updated model weight as anomalous if the reconstruction error mean(i) is not less than the mean threshold value. Similarly, the set of comparators 510 may include a second comparator to compare the reconstruction error var(i) to a variance threshold value (e_{th,var}) and classify a corresponding updated model weight as anomalous if the reconstruction error mean(i) is not less than the variance threshold value.

In various embodiments, the VAE architecture 500 leverages the probabilistic encoder structure to generate Gaussian distributions in the latent space for each data updated model weight that is characterized by mean and variance and then classifies the anomalies based on the respective distance to the mean outputs of the encoder 502 based on the existing dataset composed of only normal data, e.g., known non-anomalous data. In embodiments, the VAE architecture 500 only needs half the parameters and half the computational cost as the approach shown in FIGS. 4A-4B. The anomaly detection may be conducted by training the VAE architecture 500 using normal data for training. The probabilistic encoder q(·) may parameterize a normal distribution within the latent space with learnable mean and variance. It is then possible to monitor the resulting mean and the variance and then classify, during inference, anomalous and normal data based on the distance to the mean output of the encoder 502.

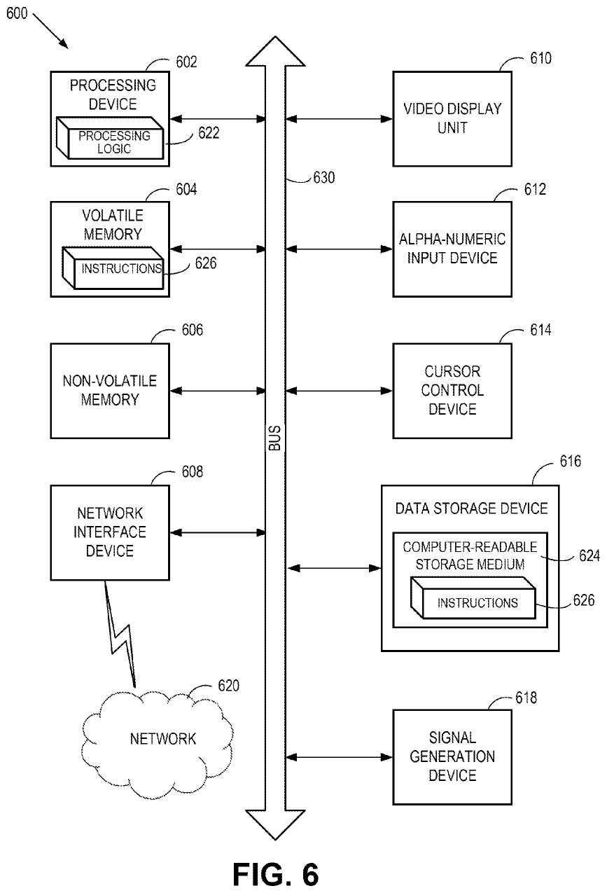

FIG. 6 illustrates a block diagram illustrating an exemplary computer device 600, in accordance with implementations of the present disclosure. Computer device 600 can correspond to one or more components of the sensors 104 and/or the central computing device 102, as described above. The computer device 600 also, when explained as a distributed system, can be understood to include the sensors 104 and the central computing device 102 in some embodiments. Example computer device 600 can be connected to other computer devices in a LAN, an intranet, an extranet, and/or the Internet. Computer device 600 can operate in the capacity of a server in a client-server network environment. Computer device 600 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 600 can include a processing device 602 (also referred to as a processor, CPU, or GPU), a volatile memory 604 (or main memory, e.g., read-only memory (ROM), flash memory, dynamic random access memory (DRAM) such as synchronous DRAM (SDRAM), etc.), a non-volatile memory 606 (e.g., flash memory, static random access memory (SRAM), etc.), and a secondary memory (e.g., a data storage device 616), which can communicate with each other via a bus 630.

Processing device 602 (which can include processing logic 622) represents one or more general-purpose processing devices such as a microcontroller, microprocessor, CPU, GPU, or the like. More particularly, processing device 602 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 can also be one or more special-purpose processing devices such as an ASIC, a FPGA, a digital signal processor (DSP), network processor, or the like. In accordance with one or more aspects of the present disclosure, processing device 602 can be configured to execute instructions performing the methods disclosed and explained herein.

Example computer device 600 can further comprise a network interface device 608, which can be communicatively coupled to a network 620. Example computer device 600 can further comprise a video display 610 (e.g., a liquid crystal display (LCD), a touch screen, or a cathode ray tube (CRT)), an alphanumeric input device 612 (e.g., a keyboard), a cursor control device 614 (e.g., a mouse), and an acoustic signal generation device 618 (e.g., a speaker).

Data storage device 616 can include a computer-readable storage medium (or, more specifically, a non-transitory computer-readable storage medium) 624 on which is stored one or more sets of executable instructions 626. In accordance with one or more aspects of the present disclosure, executable instructions 626 can comprise executable instructions performing the methods disclosed and explained herein.

Executable instructions 626 can also reside, completely or at least partially, within volatile memory 604 and/or within processing device 602 during execution thereof by example computer device 600, volatile memory 404 and processing device 602 also constituting computer-readable storage media. Executable instructions 626 can further be transmitted or received over a network via network interface device 608.

While the computer-readable storage medium 624 is shown in FIG. 6 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMS, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A method comprising:
training, by a central computing device, using data collected from a plurality of sensors, a probabilistic neural network (NN) model comprising a set of model weights, wherein the probabilistic NN model is trained to filter out data samples causing a threshold level of model uncertainty;
training, at each cycle of training the probabilistic NN model and based on the set of model weights, a common estimator to generate gradient updates to the set of model weights that are to predict whether model updates from the plurality of sensors are anomalous;
assigning, to each sensor of the plurality of sensors, a trust coefficient value that estimates a level of trustworthiness of the model updates; and
transmitting the set of model weights, by the central computing device, to a subset of sensors of the plurality of sensors for which the trust coefficient value satisfies a threshold value.

2. The method of claim 1, further comprising:
receiving, from a sensor of the subset of sensors, updated model weights for the probabilistic NN model after training a local instance of the probabilistic NN model;
evaluating, with the common estimator, the updated model weights to classify one or more of the updated model weights as anomalous; and
excluding, in retraining the common estimator, one or more of the updated model weights determined to be anomalous.

3. The method of claim 2, further comprising retraining the common estimator using non-anomalous updated model weights from the central computing device and the subset of sensors.

4. The method of claim 1, further comprising:
receiving, from a sensor of the subset of sensors, updated model weights for the probabilistic NN model after having trained a local instance of the probabilistic NN model;
evaluating, with the common estimator, the updated model weights to classify one or more of the updated model weights as anomalous; and
updating the trust coefficient value associated with the sensor based on whether each respective updated model weight is classified as anomalous.

5. The method of claim 4, wherein updating the trust coefficient value comprises:
decreasing the trust coefficient value in response to detecting an updated model weight, of the updated model weights, is anomalous; and
increasing the trust coefficient value in response to detecting an updated model weight, of the updated model weights, is non-anomalous.

6. The method of claim 4, further comprising:
determining a weighted aggregation of the updated model weights using, for each sensor of the subset of sensors, the updated trust coefficient value and an updated quantity of the data samples for each respective sensor;
modifying the updated model weights received from each respective sensor based on the weighted aggregation;
training the probabilistic NN model using the modified updated model weights to generate a set of updated model weights; and
transmitting the set of updated model weights to the subset of sensors for which the trust coefficient value satisfies the threshold value.

7. The method of claim 1, wherein the common estimator is a variational autoencoder (VAE), the method further comprising:
receiving, from a sensor of the subset of sensors, updated model weights for the probabilistic NN model;
compressing, using an encoder, the updated model weights to a latent space of a lower dimension compared to that of the updated model weights;
remapping, using a decoder, the updated model weights from the latent space to generate reconstructed updated model weights;
determining reconstruction errors between the updated model weights and the reconstructed updated model weights; and
classifying, as anomalous, one or more of the updated model weights having a corresponding reconstruction error that satisfies a second threshold value.

8. The method of claim 1, wherein the common estimator is a variational autoencoder (VAE), the method further comprising:
receiving, from a sensor of the subset of sensors, updated model weights for the probabilistic NN model;
compressing, using an encoder, the updated model weights to a latent space of a lower dimension compared to that of the updated model weights;
calculating, from the latent space, a mean of cluster centrals of the latent space using an existing dataset;
calculating a distance value between encoded samples, of the updated model weights, and the mean of cluster centrals; and
classifying as anomalous one or more of the updated model weights having a distance value that exceeds a threshold distance value.

9. A method comprising:
receiving, by a sensor of a plurality of sensors, from a central computing device, a local probabilistic neural network (NN) model having an initial set of model weights;
training the local probabilistic NN model, comprising:
determining a subset of useable data samples by identifying those of a plurality of data samples having a model uncertainty below a threshold value; and
training the local probabilistic NN model with the useable data samples to generate updated model weights; and
transferring, by the sensor, the updated model weights to the central computing device for use in training a global probabilistic NN model.

10. The method of claim 9, further comprising:
receiving, from the central computing device, further updated weights based on further training of the global probabilistic NN model; and
further training the local probabilistic NN model using the further updated weights.

11. The method of claim 9, wherein the local probabilistic NN model comprises an ensemble of classifiers or a set of Monte Carlo dropout samples, the method further comprising, during inference using the local probabilistic NN model:
combining probabilities predicted by each individual classifier in the ensemble or the set of Monte Carlo dropout samples generated;
executing the local probabilistic NN model a plurality of times with dropout enabled, each time obtaining predictions using a different dropout mask; and
combining predictions for each class across the plurality of data samples to obtain the model uncertainty.

12. The method of claim 9, wherein the local probabilistic NN model comprises an evidential deep learning (EDL) model, the method further comprising, during inference using the local probabilistic NN model:
determining estimates of the model uncertainty for each data sample; and
excluding, from training the local probabilistic NN model, data samples for which the model uncertainty at least satisfies the threshold value.

13. A non-transitory computer-readable storage medium storing instructions, which when executed, cause a processing device of a central computing device to perform operations comprising:
training, using data collected from a plurality of sensors, a probabilistic neural network (NN) model comprising a set of model weights, wherein the probabilistic NN model is trained to filter out data samples causing a threshold level of model uncertainty;
training, at each cycle of training the probabilistic NN model and based on the set of model weights, a common estimator comprising gradient updates to the set of model weights that are to predict whether model updates from the plurality of sensors are anomalous;
assigning, to each sensor of the plurality of sensors, a trust coefficient value that estimates a level of trustworthiness of the model updates; and
causing the set of model weights to be transmitted to a subset of sensors of the plurality of sensors for which the trust coefficient value satisfies a threshold value.

14. The non-transitory computer-readable storage medium of claim 13, wherein the operations further comprise:
receiving, from a sensor of the subset of sensors, updated model weights for the probabilistic NN model after training a local instance of the probabilistic NN model;
evaluating, with the common estimator, the updated model weights to classify one or more of the updated model weights as anomalous; and
excluding, in retraining the common estimator, one or more of the updated model weights determined to be anomalous.

15. The non-transitory computer-readable storage medium of claim 14, wherein the operations further comprise retraining the common estimator using non-anomalous updated model weights from the central computing device and the subset of sensors.

16. The non-transitory computer-readable storage medium of claim 13, wherein the operations further comprise:
receiving, from a sensor of the subset of sensors, updated model weights for the probabilistic NN model after having trained a local instance of the probabilistic NN model;
evaluating, with the common estimator, the updated model weights to classify one or more of the updated model weights as anomalous; and
updating the trust coefficient value associated with the sensor based on whether each respective updated model weight is classified as anomalous.

17. The non-transitory computer-readable storage medium of claim 16, wherein updating the trust coefficient value comprises:
decreasing the trust coefficient value in response to detecting an updated model weight, of the updated model weights, is anomalous; and
increasing the trust coefficient value in response to detecting an updated model weight, of the updated model weights, is non-anomalous.

18. The non-transitory computer-readable storage medium of claim 16, wherein the operations further comprise:
determining a weighted aggregation of the updated model weights using, for each sensor of the subset of sensors, the updated trust coefficient value and an updated quantity of the data samples for each respective sensor;
modifying the updated model weights received from each respective sensor based on the weighted aggregation;
training the probabilistic NN model using the modified updated model weights to generate a set of updated model weights; and
transmitting the set of updated model weights to the subset of sensors for which the trust coefficient value satisfies the threshold value.

19. The non-transitory computer-readable storage medium of claim 13, wherein the common estimator is a variational autoencoder (VAE), the operations further comprising:
receiving, from a sensor of the subset of sensors, updated model weights for the probabilistic NN model;
compressing, using an encoder, the updated model weights to a latent space of a lower dimension compared to that of the updated model weights;
remapping, using a decoder, the updated model weights from the latent space to generate reconstructed updated model weights;
determining reconstruction errors between the updated model weights and the reconstructed updated model weights; and
classifying, as anomalous, one or more of the updated model weights having a corresponding reconstruction error that satisfies a second threshold value.

20. The non-transitory computer-readable storage medium of claim 13, wherein the common estimator is a variational autoencoder (VAE), the operations further comprising:
receiving, from a sensor of the subset of sensors, updated model weights for the probabilistic NN model;
compressing, using an encoder, the updated model weights to a latent space of a lower dimension compared to that of the updated model weights;
calculating, from the latent space, a mean of cluster centrals of the latent space using an existing dataset;
calculating a distance value between encoded samples, of the updated model weights, and the mean of cluster centrals; and
classifying as anomalous one or more of the updated model weights having a distance value that exceeds a threshold distance value.
